(19) United States
(12) Patent Application Publication
(10) Pub. No.: US 2019/0050568 A1
(43) Pub. Date: Feb. 14, 2019

(54) PROCESS SEARCH APPARATUS AND COMPUTER-READABLE RECORDING MEDIUM

(71) Applicant: MITSUBISHI ELECTRIC CORPORATION, Tokyo (JP)

(72) Inventors: Eri KATAOKA, Tokyo (JP); Mitsuhiro MATSUMOTO, Tokyo (JP)

(73) Assignee: MITSUBISHI ELECTRIC CORPORATION, Tokyo (JP)

(21) Appl. No.: 16/075,532

(22) PCT Filed: Apr. 4, 2016
(86) PCT No.: PCT/JP2016/061048

§ 371 Date: Aug. 3, 2018

(51) Int. Cl. G06F 21/56; G06F 17/30

(52) U.S. Cl. CPC G06F 21/566; G06F 2221/034; G06F 17/30424

(57) ABSTRACT

An activity process list (330) is a list in which an attack type identifier and an activity process identifier are associated with each other. An operation process list (340) is a list in which an operation-source process identifier and an operation-destination process identifier are associated with each other. An indirect process searching unit (230) searches for a set of indirect process identifiers using the activity process list and the operation process list, the set of indirect process identifiers corresponding to a set of activity process identifiers associated with different attack type identifiers, and corresponding to a set of an operation-source process identifier and an operation-destination process identifier.

### TECHNICAL FIELD

The present invention relates to a technique for searching for processes related to attacks.

### BACKGROUND ART

As measures against cyber-attacks, there are systems such as an intrusion prevention system (IPS) or an intrusion detection system (IDS).

These systems are to detect malware by checking application or process activities against known patterns of malware, and thus, cannot detect malware having unknown patterns.

Patent Literatures 1 to 4 disclose techniques that use the fact that a targeted attack proceeds in a stepwise manner, to detect unknown malware. The unknown malware is malware having unknown patterns.

In these techniques, combinations of known attacks are defined as attack scenarios. Then, by comparing the order of occurrence of processes with the attack scenarios, proceeding of an attack is detected.

By performing detection using the attack scenarios, behavior of unknown malware can be detected. However, attacks that are not related to each other may be detected as a series of attacks, and thus, there is a possibility that there may be many erroneous detections.

Patent Literatures 5 and 6 disclose techniques for detecting behavior of malicious processes by focusing attention on relationships between processes, to detect unknown malware. The relationships between processes are specifically relationships between network access and file access, call relationships between processes, etc.

In these techniques, the relationships between processes are updated every time a process occurs on a terminal. Then, when a malicious process is detected, a relationship between processes is searched for, by which processes related to the detected process are detected as malicious processes. The detected malicious processes form a series of attacks.

Patent Literature 7 discloses a technique for holding relationships between processes by combining a network access log and a terminal log in order to determine a malicious process.

In this technique, a malicious process that cannot be detected only by monitoring communication is detected.

In the techniques disclosed in Patent Literatures 5 to 7, there is a need to generate relationships between processes and update the relationships between processes to maintain the latest state. In addition, when behavior of a malicious process is detected, there is a need to search for a relationship between processes.

When all relationships between processes are held, the relationships between processes become complex and huge, and thus, an efficient search is required.

Meanwhile, if a completed process is deleted from the relationships between processes, then the relationships between processes are avoided from becoming complex and huge. However, when the deleted process is found out later to be an attack or a process that connects attacks, it becomes difficult to perform accurate detection.

### CITATION LIST

### Patent Literature

Patent Literature 1: JP 2015-121968 A

Patent Literature 2: WO 2014/112185 A

Patent Literature 3: WO 2015/059791 A

Patent Literature 4: WO 2014/045827 A

Patent Literature 5: JP 2011-501279 A

Patent Literature 6: JP 2013-543624 A

Patent Literature 7: JP 2011-053893 A

### SUMMARY OF INVENTION

### Technical Problem

An object of the present invention is to allow to search for a relationship between processes related to attacks.

### Solution to Problem

A process search apparatus according to the present invention includes:

a storage unit to store an activity process list in which an attack type identifier of a type of a detected attack and an activity process identifier of an activity process performed during a time period during which the attack is detected are associated with each other, and an operation process list in which an operation-source process identifier of an operation-source process having operated another process during the time period during which the attack is detected and an operation-destination process identifier of an operation-destination process that is the another process operated are associated with each other; and

an indirect process searching unit to search for a set of indirect process identifiers using the activity process list and the operation process list, the set of indirect process identifiers corresponding to a set of activity process identifiers associated with different attack type identifiers, and corresponding to a set of an operation-source process identifier and an operation-destination process identifier.

### Advantageous Effects of Invention

According to the present invention, a set of related process identifiers indicating a relationship between processes related to attacks can be searched for.

### BRIEF DESCRIPTION OF DRAWINGS

FIG. 1 is a configuration diagram of a process search system 100 of a first embodiment.

FIG. 2 is a configuration diagram of a process search apparatus 200 of the first embodiment.

FIG. 3 is a flowchart of a process search method of the first embodiment.

FIG. 4 is a configuration diagram of an activity log file 310 of the first embodiment.

FIG. 5 is a configuration diagram of an attack log file 320 of the first embodiment.

FIG. 6 is a configuration diagram of an activity process list 330 of the first embodiment.

FIG. 7 is a flowchart of an activity process extraction processing (S120) of the first embodiment.

FIG. 8 is a configuration diagram of an operation process list 340 of the first embodiment.

FIG. 9 is a flowchart of an operation process extraction processing (S130) of the first embodiment.

FIG. 10 is an overview diagram of a recursive search for direct processes of the first embodiment.

FIG. 11 is a flowchart of a direct process search processing (S140) of the first embodiment.

FIG. 12 is a configuration diagram of an indirect process file 360 of the first embodiment.

FIG. 13 is a flowchart of an indirect process search processing (S150) of the first embodiment.

FIG. 14 is a flowchart of a backward search processing (S210) of the first embodiment.

FIG. 15 is a flowchart of the backward search processing (S210) of the first embodiment.

FIG. 16 is a flowchart of a data generation processing (S230) of the first embodiment.

FIG. 17 is a flowchart of a forward search processing (S220) of the first embodiment.

FIG. 18 is a flowchart of the forward search processing (S220) of the first embodiment.

FIG. 19 is a diagram illustrating an example of a process configuration of the first embodiment.

FIG. 20 is a diagram illustrating an example of indirect process data 361 of the first embodiment.

FIG. 21 is a flowchart of a process search method of a second embodiment.

FIG. 22 is a flowchart of an indirect process search processing (S300) of the second embodiment.

FIG. 23 is a flowchart of a forward search processing (S310) of the second embodiment.

FIG. 24 is a flowchart of the forward search processing (S310) of the second embodiment.

FIG. 25 is a diagram illustrating an example of indirect process data 361 of the second embodiment.

FIG. 26 is a diagram illustrating an indirect process file 360 of the second embodiment.

FIG. 27 is a hardware configuration diagram of the process search apparatus 200 of the embodiments.

### DESCRIPTION OF EMBODIMENTS

### First Embodiment

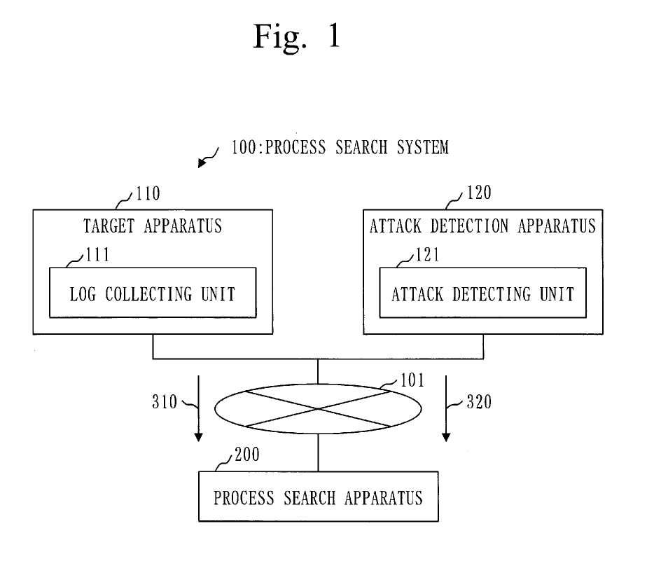

A process search system 100 will be described based on FIGS. 1 to 20.

***Description of a Configuration***

A configuration of the process search system 100 will be described based on FIG. 1.

The process search system 100 is a system that searches for processes related to attacks on a target apparatus 110.

The process search system 100 includes the target apparatus 110, an attack detection apparatus 120, and a process search apparatus 200.

The target apparatus 110 is a target for detection of attacks.

The attack detection apparatus 120 detects attacks on the target apparatus 110.

The process search apparatus 200 searches for processes related to the attacks on the target apparatus 110.

The target apparatus 110, the attack detection apparatus 120, and the process search apparatus 200 communicate with each other through a network 101.

The target apparatus 110 is a computer including hardware such as a processor, a memory, and a communication apparatus.

The target apparatus 110 includes a log collecting unit 111 as a functional configuration element. A program that implements the function of the log collecting unit 111 is loaded into the memory and executed by the processor.

The log collecting unit 111 collects logs by conventional techniques, and generates an activity log file 310 which will be described later.

The attack detection apparatus 120 is a computer including hardware such as a processor, a memory, and a communication apparatus.

The attack detection apparatus 120 includes an attack detecting unit 121 as a functional configuration element. A program that implements the function of the attack detecting unit 121 is loaded into the memory and executed by the processor.

The attack detecting unit 121 detects attacks on the target apparatus 110 by conventional techniques, and generates an attack log file 320 which will be described later.

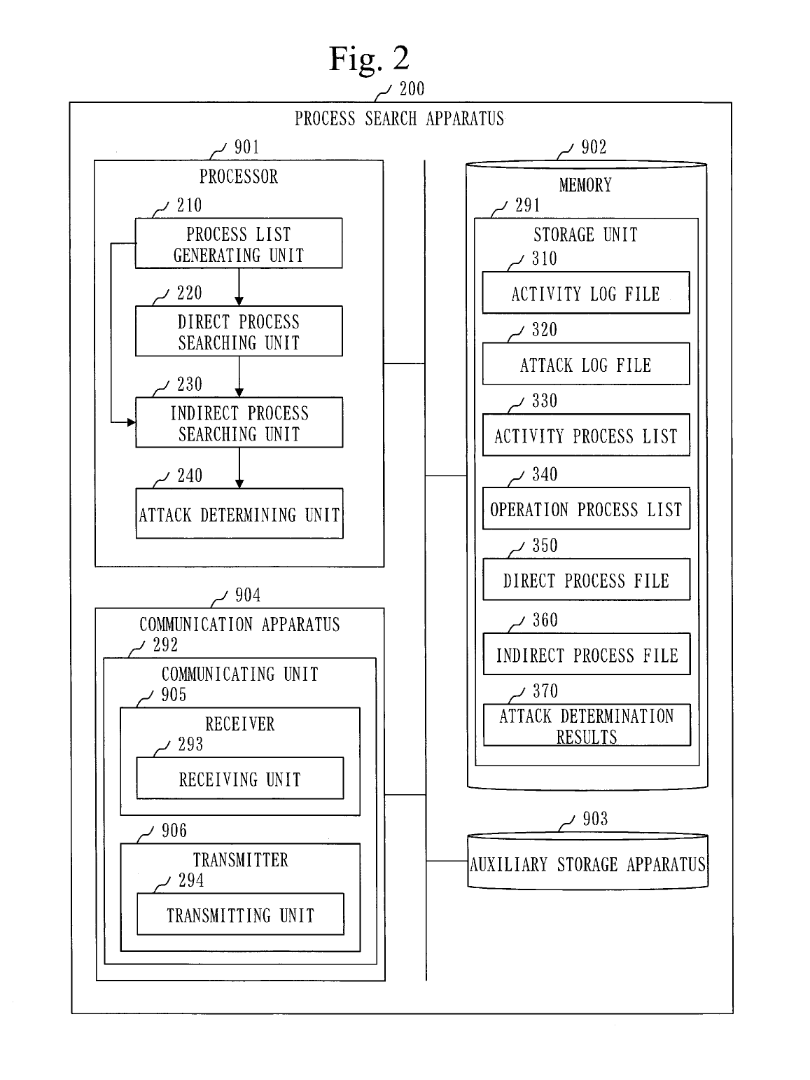

A configuration of the process search apparatus 200 will be described based on FIG. 2.

The process search apparatus 200 is a computer including hardware such as a processor 901, a memory 902, an auxiliary storage apparatus 903, and a communication apparatus 904. The processor 901 is connected to other hardware through signal lines.

The processor 901 is an integrated circuit (IC) that performs processing, and controls other hardware. Specifically, the processor 901 is a CPU, a DSP, or a GPU. The CPU is the abbreviation for central processing unit, the DSP is the abbreviation for digital signal processor, and the GPU is the abbreviation for graphics processing unit.

The memory 902 is a volatile storage apparatus. The memory 902 is also called a main storage apparatus or a main memory. Specifically, the memory 902 is a random access memory (RAM).

The auxiliary storage apparatus 903 is a nonvolatile storage apparatus. Specifically, the auxiliary storage apparatus 903 is a ROM, an HDD, or a flash memory. The ROM is the abbreviation for read only memory, and the HDD is the abbreviation for hard disk drive.

The communication apparatus 904 is an apparatus that performs communication, and includes a receiver 905 and a transmitter 906. Specifically, the communication apparatus 904 is a communication chip or a network interface card (NIC).

The process search apparatus 200 includes “units” such as a process list generating unit 210, a direct process searching unit 220, an indirect process searching unit 230, and an attack determining unit 240, as functional configuration elements. The functions of the “units” are implemented by software. The functions of the “units” will be described later.

In the auxiliary storage apparatus 903 there is stored a program that implements the functions of the “units”. The program that implements the functions of the “units” is loaded into the memory 902 and executed by the processor 901.

Furthermore, in the auxiliary storage apparatus 903 there is stored an operating system (OS). At least a part of the OS is loaded into the memory 902 and executed by the processor 901.

That is, the processor 901 executes the program that implements the functions of the “units” while executing the OS.

Data obtained by executing the program that implements the functions of the “units” is stored in a storage apparatus such as the memory 902, the auxiliary storage apparatus 903, a register in the processor 901, or a cache memory in the processor 901. These storage apparatuses function as a storage unit 291 that stores data.

Note that the process search apparatus 200 may include a plurality of processors 901, and the plurality of processors 901 may execute the program that implements the functions of the “units” in cooperation with each other.

The memory 902 stores data to be used, generated, inputted/outputted, or transmitted/received by the process search apparatus 200.

Specifically, the memory 902 stores an activity log file 310, an attack log file 320, an activity process list 330, an operation process list 340, a direct process file 350, an indirect process file 360, attack determination results 370, etc. The content of data stored in the memory 902 will be described later.

The communication apparatus 904 functions as a communicating unit 292 that communicates data, the receiver 905 functions as a receiving unit 293 that receives data, and the transmitter 906 functions as a transmitting unit 294 that transmits data.

Hardware in which the processor 901, the memory 902, and the auxiliary storage apparatus 903 are put together is referred to as “processing circuitry”.

The “units” may be read as “processes” or “steps”. The functions of the “units” may be implemented by firmware.

The program that implements the functions of the “units” may be stored in a nonvolatile storage medium such as a magnetic disk, an optical disc, or a flash memory.

***Description of Operation***

The operation of the process search apparatus 200 corresponds to a process search method. In addition, a procedure of the process search method corresponds to a procedure of a process search program.

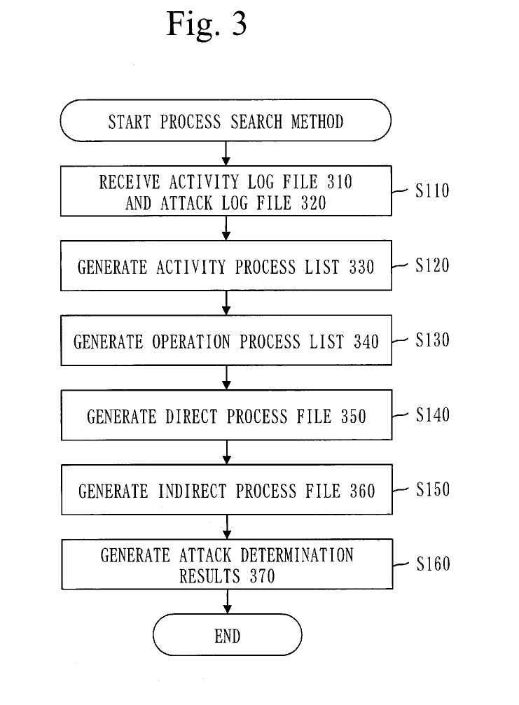

The process search method will be described based on FIG. 3.

Step S110 is a reception processing.

At step S110, the receiving unit 293 receives an activity log file 310 from the target apparatus 110.

The activity log file 310 is data in which an activity time, an activity process identifier, and a parent process identifier are associated with one another, and an operation-destination process identifier is associated with the activity process identifier of an activity process corresponding to an operation-source process.

The activity time is a time at which an activity process is performed.

The activity process is a process performed at the activity time.

The activity process identifier is a process identifier that identifies the activity process.

The process identifier is an identifier that identifies a process.

The parent process identifier is an identifier that identifies a parent process.

The parent process is a process that has generated the activity process.

The operation-source process is a process that operates another process.

The operation-destination process identifier is a process identifier that identifies an operation-destination process.

The operation-destination process is a process operated by the operation-source process.

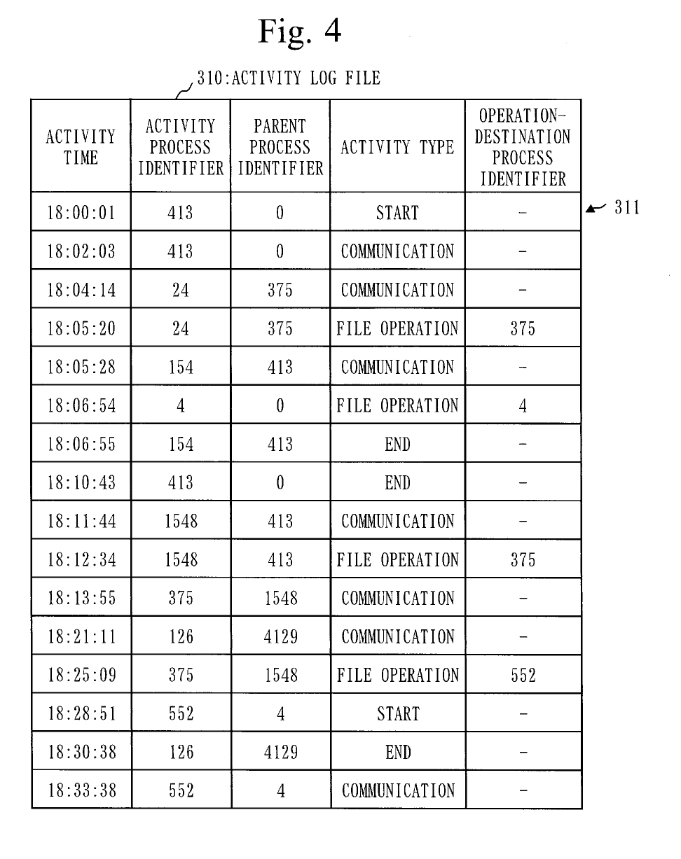

A specific configuration of the activity log file 310 will be described based on FIG. 4.

The activity log file 310 includes one or more activity logs 311. One row in the drawing corresponds to an activity log 311.

The activity log 311 includes an activity time, an activity process identifier, a parent process identifier, an activity type, and an operation-destination process identifier such that they are associated with one another.

The activity type is information indicating a type of activity of an activity process.

Referring back to FIG. 3, the description of step S110 continues.

Furthermore, the receiving unit 293 receives an attack log file 320 from the attack detection apparatus 120.

The attack log file 320 is data in which an attack type identifier and an attack time period are associated with each other.

The attack type identifier is an identifier that identifies the type of attack detected. Specifically, the attack type identifier is a number indicating the order of attacks.

The attack time period is a time period during which the attack is detected. Specifically, the attack time period is indicated by an attack start time and an attack end time.

The attack start time is a start time of the attack time period.

The attack end time is an end time of the attack time period.

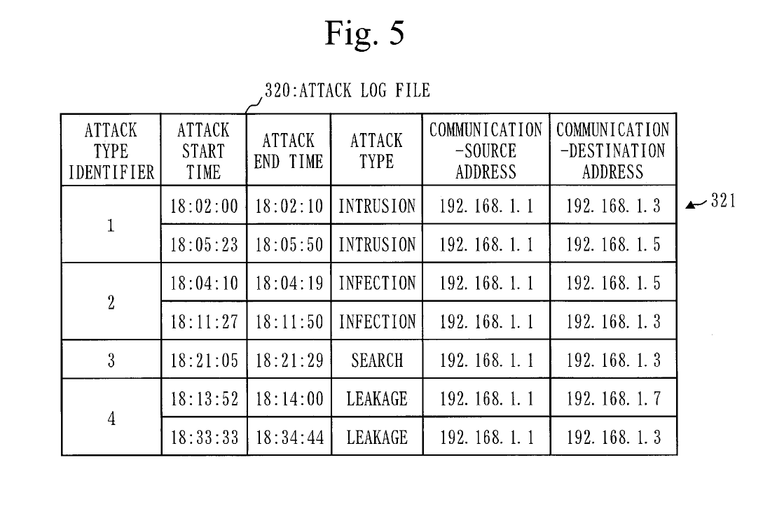

A specific configuration of the attack log file 320 will be described based on FIG. 5.

The attack log file 320 includes one or more attack logs 321. One row in the drawing corresponds to an attack log 321.

The attack log 321 includes an attack type identifier, an attack start time, an attack end time, an attack type, a communication-source address, and a communication-destination address such that they are associated with one another.

The attack type is information indicating the type of attack.

The communication-source address is the address of a communication source of suspicious communication which is detected as an attack. Specifically, the communication-source address is an IP address. The IP is the abbreviation for Internet protocol.

The communication-destination address is the address of a communication destination of the suspicious communication which is detected as an attack. Specifically, the communication-destination address is an IP address.

Referring back to FIG. 3, description continues from step S120.

Step S120 is a process generation processing for generating an activity process list 330. Step S120 is hereinafter referred to as activity process extraction processing.

At step S120, the process list generating unit 210 generates an activity process list 330 using the activity log file 310 and the attack log file 320.

The activity process list 330 is data in which an attack type identifier, an activity process identifier, and an attack time period are associated with one another.

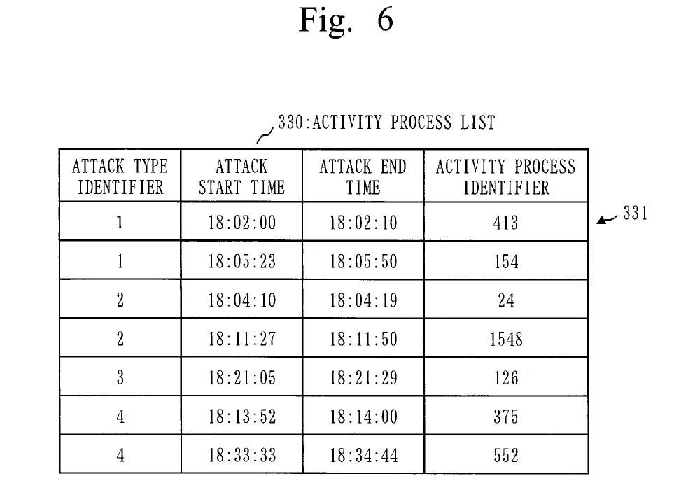

A specific configuration of the activity process list 330 will be described based on FIG. 6.

The activity process list 330 includes one or more activity process data 331. One row in the drawing corresponds to activity process data 331.

The activity process data 331 includes an attack type identifier, an attack start time, an attack end time, and an activity process identifier such that they are associated with one another.

The activity process list 330 of FIG. 6 is generated using the activity log file 310 of FIG. 4 and the attack log file 320 of FIG. 5.

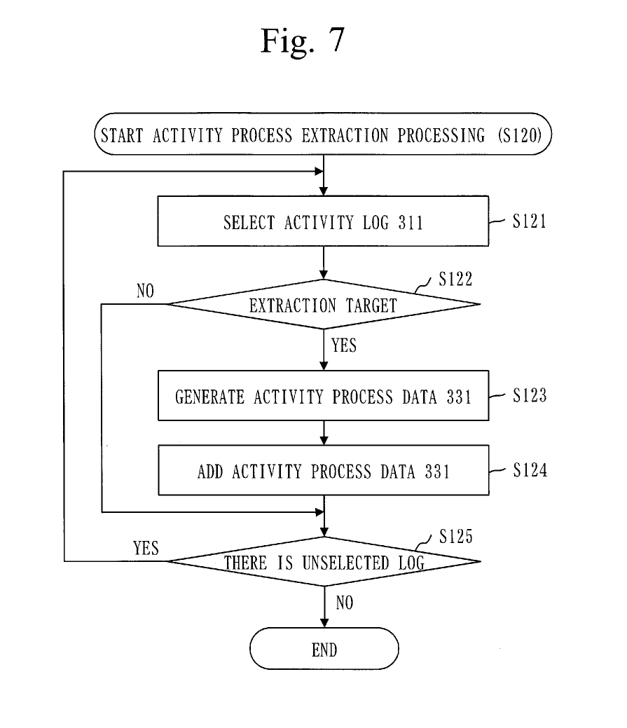

A procedure of the activity process extraction processing (S120) will be described based on FIG. 7.

At step S121, the process list generating unit 210 selects one unselected activity log 311 from the activity log file 310.

Specifically, the process list generating unit 210 selects activity logs 311 one by one in ascending order of activity times.

At step S122, the process list generating unit 210 determines whether an activity process corresponding to the selected activity log 311 is an extraction target process. The extraction target process is an activity process to be extracted.

Specifically, the process list generating unit 210 obtains an activity time from the selected activity log 311. Then, by referring to the attack log file 320, the process list generating unit 210 determines whether the obtained activity time is included in any of the attack time periods. When the obtained activity time is included in any of the attack time periods, the activity process corresponding to the selected activity log 311 is an extraction target process.

If the activity process corresponding to the selected activity log 311 is an extraction target process, processing proceeds to step S123.

If the activity process corresponding to the selected activity log 311 is not an extraction target process, processing proceeds to step S125.

At step S123, the process list generating unit 210 generates activity process data 331 for the selected activity log 311.

Specifically, the process list generating unit 210 generates activity process data 331 as follows:

First, the process list generating unit 210 obtains an activity time and an activity process identifier from the selected activity log 311.

Then, the process list generating unit 210 selects an attack time period including the obtained activity time from the attack log file 320.

Then, the process list generating unit 210 obtains an attack type identifier, an attack start time, and an attack end time that are associated with the selected attack time period, from the attack log file 320.

Then, the process list generating unit 210 generates activity process data 331 by associating the obtained attack type identifier, attack start time, attack obtaining time, and activity process identifier with one another.

At step S124, the process list generating unit 210 adds the generated activity process data 331 to the activity process list 330.

At step S125, the process list generating unit 210 determines whether there is an unselected activity log 311 in the activity log file 310.

If there is an unselected activity log 311, processing returns to step S121.

If there is no unselected activity log 311, the activity process extraction processing (S120) ends.

Referring back to FIG. 3, description continues from step S130.

Step S130 is a process generation processing for generating an operation process list 340. Step S130 is hereinafter referred to as operation process extraction processing.

At step S130, the process list generating unit 210 generates an operation process list 340 using the activity log file 310.

The operation process list 340 is data in which an operation-source process identifier and an operation-destination process identifier are associated with each other.

The operation-source process identifier is an identifier that identifies an operation-source process.

The operation-source process is an activity process that has operated an operation-destination process.

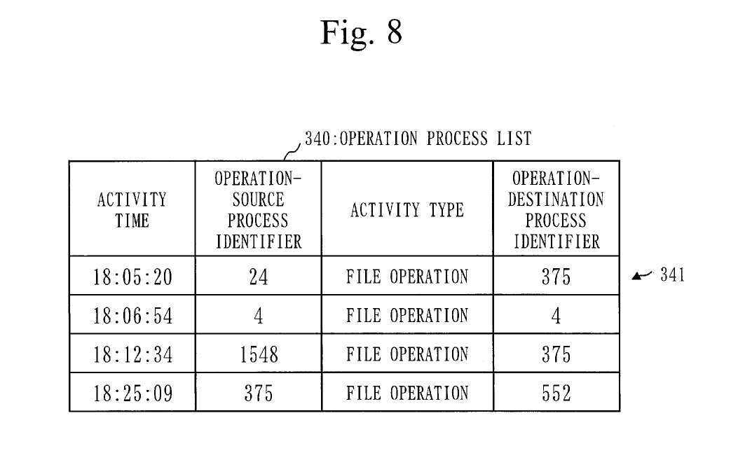

A specific configuration of the operation process list 340 will be described based on FIG. 8.

The operation process list 340 includes one or more operation process data 341. One row in the drawing corresponds to operation process data 341.

The operation process data 341 includes an activity time, an operation-source process identifier, an activity type, and an operation-destination process identifier such that they are associated with one another.

The activity process list 330 of FIG. 8 is generated using the activity log file 310 of FIG. 4.

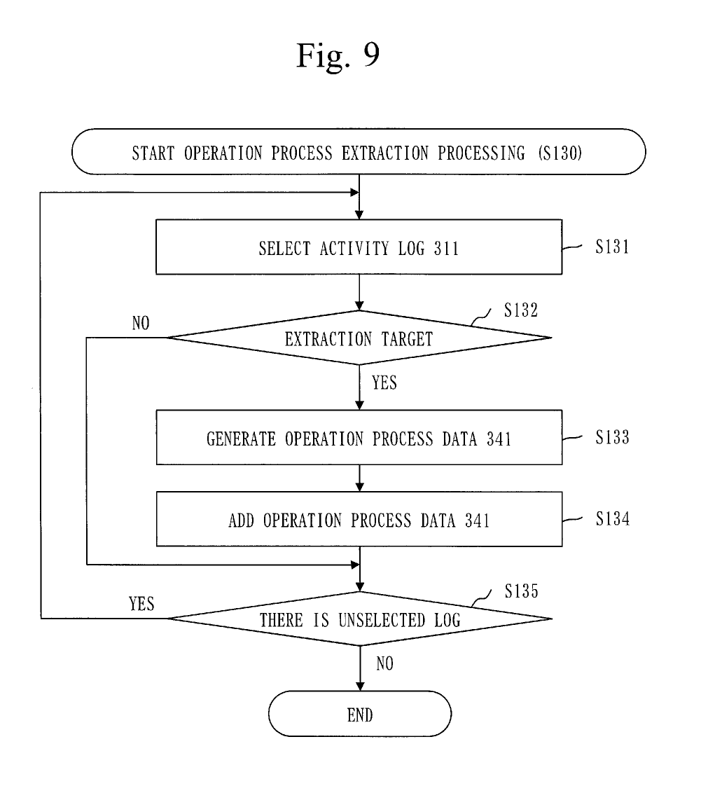

A procedure of the operation process extraction processing (S130) will be described based on FIG. 9.

At step S131, the process list generating unit 210 selects one unselected activity log 311 from the activity log file 310.

Specifically, the process list generating unit 210 selects activity logs 311 one by one in ascending order of activity times. Note, however, that the process list generating unit 210 may select activity logs 311, targeted for those activity logs 311 including activity times included in the entire attack time period. The entire attack time period is a time period from the earliest attack start time included in the attack log file 320 to the latest attack end time included in the attack log file 320.

At step S132, the process list generating unit 210 determines whether an activity process corresponding to the selected activity log 311 is an extraction target process. The extraction target process is an activity process to be extracted.

Specifically, the process list generating unit 210 determines whether the selected activity log 311 includes an operation-destination process identifier. When the selected activity log 311 includes an operation-destination process identifier, the activity process corresponding to the selected activity log 311 is an extraction target process.

If the activity process corresponding to the selected activity log 311 is an extraction target process, processing proceeds to step S133.

If the activity process corresponding to the selected activity log 311 is not an extraction target process, processing proceeds to step S135.

At step S133, the process list generating unit 210 generates operation process data 341 for the selected activity log 311.

Specifically, the process list generating unit 210 generates operation process data 341 as follows:

First, the process list generating unit 210 obtains an activity process identifier as an operation-source process identifier from the selected activity log 311.

In addition, the process list generating unit 210 obtains an activity time, an activity type, and an operation-destination process identifier from the selected activity log 311.

Then, the process list generating unit 210 generates an operation process data 341 by associating the obtained activity time, operation-source process identifier, activity type, and operation-destination process identifier with one another.

At step S134, the process list generating unit 210 adds the generated operation process data 341 to the operation process list 340.

At step S135, the process list generating unit 210 determines whether there is an unselected activity log 311 in the activity log file 310.

If there is an unselected activity log 311, processing returns to step S131.

If there is no unselected activity log 311, the operation process extraction processing (S130) ends.

Referring back to FIG. 3, description continues from step S140.

Step S140 is a direct process search processing.

At step S140, the direct process searching unit 220 searches for a set of direct process identifiers using the activity process list 330 and the activity log file 310, and generates a direct process file 350.

The set of direct process identifiers corresponds to a set of an activity process identifier and a parent process identifier, and corresponds to a set of activity process identifiers included in the activity process list 330.

The direct process file 350 is data representing sets of direct process identifiers.

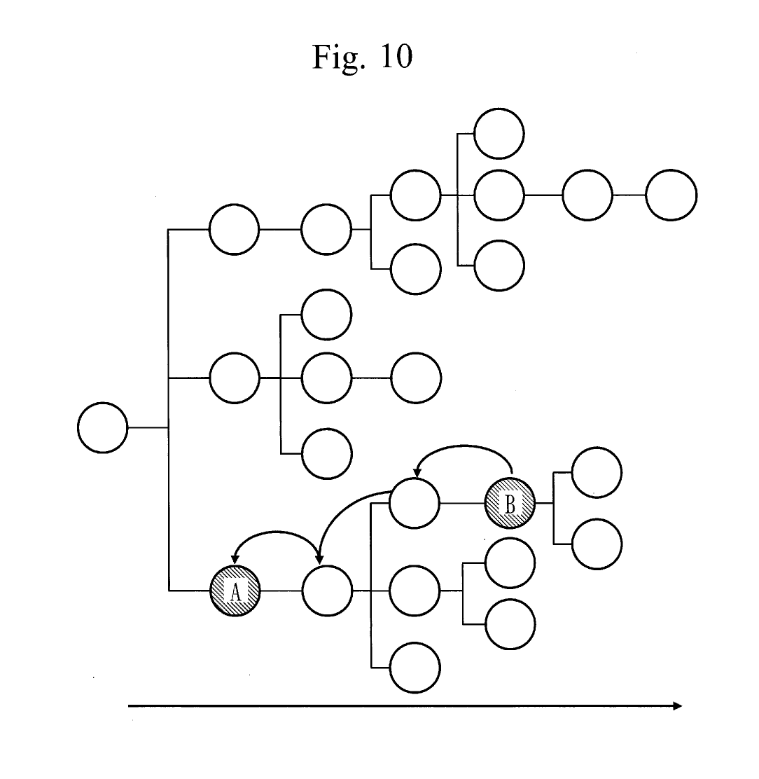

An overview of a processing of recursively searching for direct processes will be described based on FIG. 10.

A parent-child relationship (call relationship) between processes can be represented by a tree structure. In the tree structure, a process corresponds to a node and a parent-child relationship between processes corresponds to an edge. In FIG. 10, a circle represents a node and a line that connects nodes represents an edge.

When an attack start time for a process B is later than an attack start time for a process A, in the direct process search processing (S140), parent processes are recursively traced from the process B, reaching the process A.

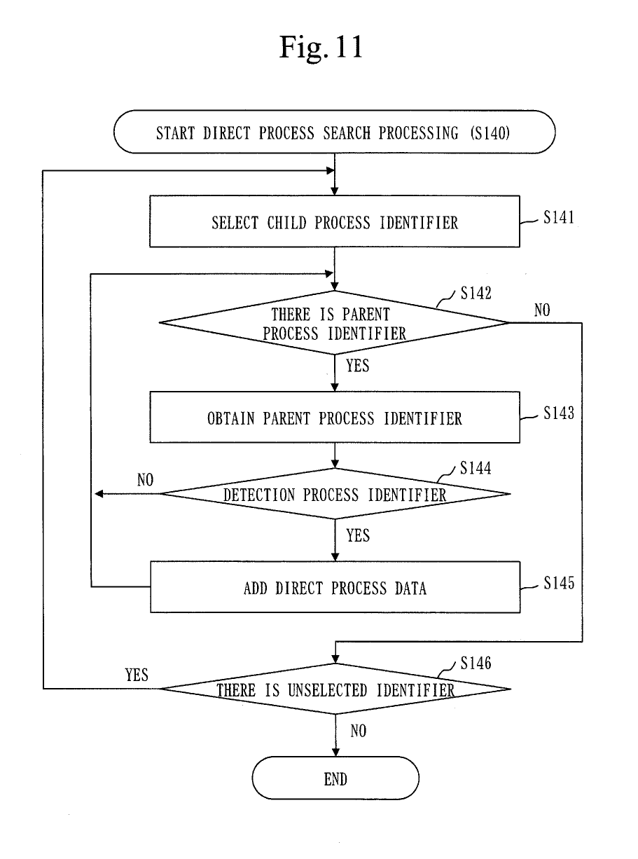

A procedure of the direct process search processing (S140) will be described based on FIG. 11.

At step S141, the direct process searching unit 220 selects one unselected activity process identifier from the activity process list 330.

Specifically, the direct process searching unit 220 selects activity process identifiers one by one in descending order of attack start times.

The activity process identifier to be selected is referred to as child process identifier.

At step S142, the direct process searching unit 220 determines whether there is a parent process identifier for the child process identifier in the activity log file 310.

The parent process identifier for the child process identifier is a parent process identifier associated with an activity process identifier identical to the child process identifier.

If there is a parent process identifier for the child process identifier in the activity log file 310, processing proceeds to step S143.

If there is no parent process identifier for the child process identifier in the activity log file 310, processing proceeds to step S146.

At step S143, the direct process searching unit 220 obtains the parent process identifier for the child process identifier from the activity log file 310.

At step S144, the direct process searching unit 220 determines whether the S20 obtained parent process identifier is a detection process identifier.

The detection process identifier is an activity process identifier included in the activity process list 330.

Specifically, the direct process searching unit 220 determines whether the activity process list 330 includes an activity process identifier identical to the obtained parent process identifier. When the activity process list 330 includes the activity process identifier, the obtained parent process identifier is a detection process identifier.

If the obtained parent process identifier is a detection process identifier, processing proceeds to step S145.

If the obtained parent process identifier is not a detection process identifier, then the obtained parent process identifier is a child process identifier, and thus, processing returns to step S142.

At step S145, the direct process searching unit 220 includes, in the direct process file 350, a set of the obtained parent process identifier and the selected child process identifier as a set of direct process identifiers.

Specifically, the direct process searching unit 220 generates direct process data including a set of the parent process identifier and the child process identifier, and adds the generated direct process data to the direct process file 350.

A configuration of the direct process data is the same as that of indirect process data 361 which will be described later, and the direct process data includes an origin process identifier, a search type identifier, a search process identifier, relationship information, and an additional-process identifier.

In the direct process data to be generated, the origin process identifier, the search type identifier, the search process identifier, the relationship information, and the additional-process identifier are as follows:

The origin process identifier is the child process identifier.

The search type identifier is an attack type identifier in the activity process list 330 that is associated with an activity process identifier identical to the parent process identifier.

The search process identifier is the parent process identifier.

The relationship information indicates that there is a relationship.

The additional-process identifier is blank.

After step S145, the obtained parent process identifier serves as a child process identifier, and processing returns to step S142.

At step S146, the direct process searching unit 220 determines whether there is an unselected activity process identifier that is not selected as a child process identifier in the activity process list 330.

If there is an unselected activity process identifier, processing returns to step S141.

If there is no unselected activity process identifier, the direct process search processing (S140) ends.

Referring back to FIG. 3, description continues from step S150.

Step S150 is an indirect process search processing.

At step S150, the indirect process searching unit 230 searches for a set of indirect process identifiers using the activity process list 330 and the operation process list 340, and generates an indirect process file 360.

The set of indirect process identifiers corresponds to a set of activity process identifiers associated with different attack type identifiers, and corresponds to a set of an operation-source process identifier and an operation-destination process identifier.

The indirect process file 360 is data representing a set of indirect process identifiers.

The indirect process search processing (S150) has the following features:

The indirect process searching unit 230 selects an origin type identifier from the attack type identifiers included in the activity process list 330, based on the number of activity process identifiers associated with each attack type identifier. The origin type identifier is an attack type identifier serving as the origin of a search.

The indirect process searching unit 230 searches for a set of indirect process identifiers using activity process identifiers associated with the origin type identifier.

The indirect process searching unit 230 selects, as an origin type identifier, an attack type identifier with the smallest number of associated activity process identifiers among the attack type identifiers included in the activity process list 330.

The indirect process searching unit 230 selects an activity process identifier associated with the origin type identifier from the activity process list 330. The activity process identifier to be selected is referred to as origin process identifier.

The indirect process searching unit 230 selects an attack type identifier different from the origin type identifier, from the activity process list 330. The attack type identifier to be selected is referred to as search type identifier.

The indirect process searching unit 230 selects an activity process identifier associated with the search type identifier, from the activity process list 330. The activity process identifier to be selected is referred to as search process identifier.

The indirect process searching unit 230 determines whether the operation process list 340 includes a set of an operation-destination process identifier and an operation-source process identifier corresponding to a set of the origin process identifier and the search process identifier.

The attack type identifier is a number indicating the order of attacks.

The indirect process searching unit 230 selects an attack type identifier indicating a number immediately before a number indicated by the origin type identifier. The attack type identifier to be selected is the search type identifier.

When the operation process list 340 includes a set of an operation-destination process identifier and an operation-source process identifier corresponding to a set of the origin process identifier and the search process identifier, and the number indicated by the search type identifier is the first number, the indirect process searching unit 230 generates the set of the origin process identifier and the search process identifier as a set of indirect process identifiers.

When the operation process list 340 includes a set of an operation-destination process identifier and an operation-source process identifier corresponding to a set of the origin process identifier and the search process identifier, but the number indicated by the search type identifier is not the first number, the indirect process searching unit 230 operates as follows:

The indirect process searching unit 230 selects an activity process identifier associated with the search type identifier. The activity process identifier to be selected is a new origin process identifier.

The indirect process searching unit 230 selects an attack type identifier indicating a number immediately before the number indicated by the search type identifier. The attack type identifier to be selected is a new search type identifier.

The indirect process searching unit 230 selects an activity process identifier associated with the new search type identifier. The activity process identifier to be selected is a new search process identifier.

When the operation process list 340 includes a set of an operation-destination process identifier and an operation-source process identifier corresponding to a set of the new origin process identifier and the new search process identifier, and the number indicated by the new search type identifier is the first number, the indirect process searching unit 230 operates as follows. The indirect process searching unit 230 generates, as a set of indirect process identifiers, the set of the origin process identifier and the search process identifier and the set of the new origin process identifier and the new search process identifier.

The indirect process searching unit 230 selects, as a search process identifier, each of the activity process identifiers associated with the search type identifier from the activity process list 330 in ascending order of attack start times.

The indirect process searching unit 230 selects an operation-source process identifier identical to the search process identifier from the operation process list 340.

The indirect process searching unit 230 obtains an operation-destination process identifier associated with the selected operation-source process identifier, from the operation process list 340. The operation-destination process identifier to be obtained is referred to as additional-process identifier.

When the operation process list 340 includes a set of an operation-destination process identifier and an operation-source process identifier corresponding to a set of the origin process identifier and the search process identifier, and the number indicated by the search type identifier is the first number, the indirect process searching unit 230 generates a set of indirect process identifiers. The set of indirect process identifiers is a set of the origin process identifier, the search process identifier, and the additional-process identifier.

When the search process identifier is identical to an additional-process identifier for a search process identifier selected previously, the indirect process searching unit 230 omits a processing for a set of the origin process identifier and the search process identifier.

The indirect process searching unit 230 selects an attack type identifier indicating a number immediately after the number indicated by the origin type identifier. The attack type identifier to be selected is a new search type identifier.

The indirect process searching unit 230 selects an activity process identifier associated with the new search type identifier. The activity process identifier to be selected is a new search process identifier.

When the operation process list 340 includes a set of an operation-destination process identifier and an operation-source process identifier corresponding to a set of the new origin process identifier and the new search process identifier, the indirect process searching unit 230 generates the set of the new origin process identifier and the new search process identifier as a set of indirect process identifiers.

The indirect process searching unit 230 selects, as a new search process identifier, each of the activity process identifiers associated with the search type identifier from the activity process list 330 in descending order of attack start times.

The indirect process searching unit 230 selects an operation-source process identifier identical to the new search process identifier from the operation process list 340.

The indirect process searching unit 230 obtains an operation-source process identifier associated with the selected operation-source process identifier, from the operation process list 340. The operation-source process identifier to be obtained is referred to as additional-process identifier.

The indirect process searching unit 230 adds the additional-process identifier to the set of the origin process identifier and the search process identifier.

When the new search process identifier is an identifier identical to an additional-process identifier for a search process identifier selected previously, the indirect process searching unit 230 omits a processing for a set of the origin process identifier and the new search process identifier.

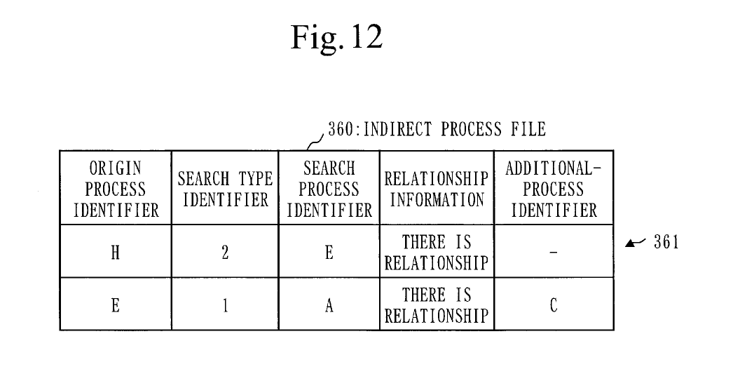

A specific configuration of the indirect process file 360 will be described based on FIG. 12.

The indirect process file 360 includes one or more indirect process data 361. One row in the drawing corresponds to indirect process data 361.

The indirect process data 361 includes an origin process identifier, a search type identifier, a search process identifier, relationship information, and an additional-process identifier such that they are associated with one another.

A set of the origin process identifier, the search process identifier, and the additional-process identifier corresponds to a set of indirect process identifiers.

The origin process identifier is an identifier that identifies an origin process.

The origin process is a process serving as the origin of a search.

The search type identifier is an attack type identifier serving as a search target.

The search process identifier is an identifier that identifies a search process.

The search process is an activity process serving as a search target.

The relationship information is information indicating whether there is a relationship between the origin process and the search process. When there is a relationship between the origin process and the search process, the origin process identifier and the search process identifier are included in the set of indirect process identifiers.

The additional-process identifier is an identifier that identifies an additional process.

The additional process is a process related to the search process.

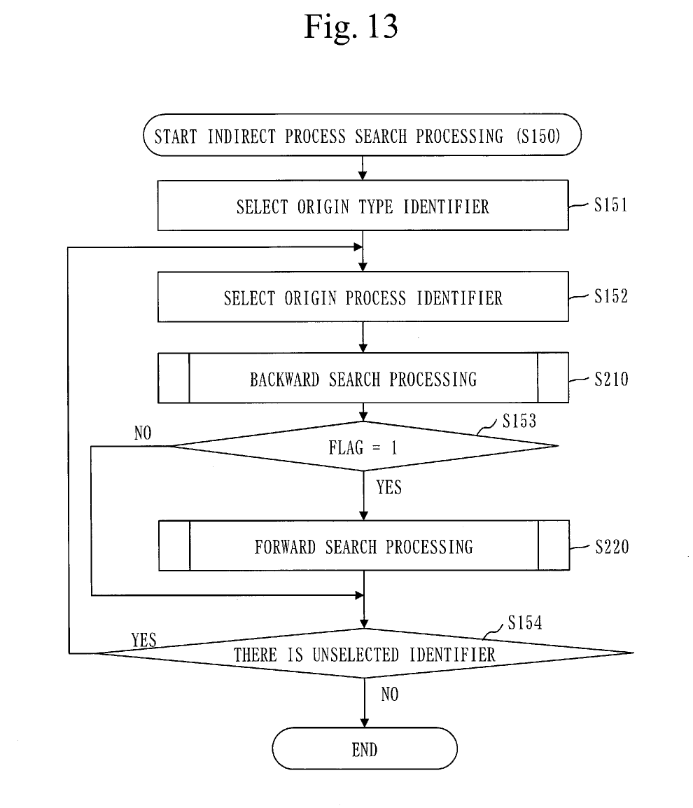

A procedure of the indirect process search processing (S150) will be described based on FIG. 13.

At step S151, the indirect process searching unit 230 selects an origin type identifier from the attack type identifiers included in the activity process list 330.

The origin type identifier is an attack type identifier serving as the origin of a search.

Specifically, the indirect process searching unit 230 selects an origin type identifier based on the number of activity process identifiers associated with each attack type identifier.

More specifically, the indirect process searching unit 230 selects, as an origin type identifier, an attack type identifier with the smallest number of associated activity process identifiers among the attack type identifiers included in the activity process list 330.

At step S152, the indirect process searching unit 230 selects an unselected activity process identifier as an origin process identifier from the activity process list 330.

The origin process identifier is an activity process identifier associated with the origin type identifier.

Specifically, the indirect process searching unit 230 selects an activity process identifier as an origin process identifier in descending order of attack start times.

Step S210 is a backward search processing.

The backward search processing (S210) will be described later.

After step S210, processing proceeds to step S153.

At step S153, the indirect process searching unit 230 determines whether the value of a forward search flag which will be described later is 1.

If the value of the forward search flag is 1, processing proceeds to step S220.

If the value of the forward search flag is 0, processing proceeds to step S154.

Step S220 is a forward search processing.

The forward search processing (S220) will be described later.

After step S220, processing proceeds to step S154.

At step S154, the indirect process searching unit 230 determines whether there is an unselected activity process identifier that is not selected as an origin process identifier at S152.

If there is an unselected activity process identifier, processing returns to step S152.

If there is no unselected activity process identifier, the indirect process search processing (S150) ends.

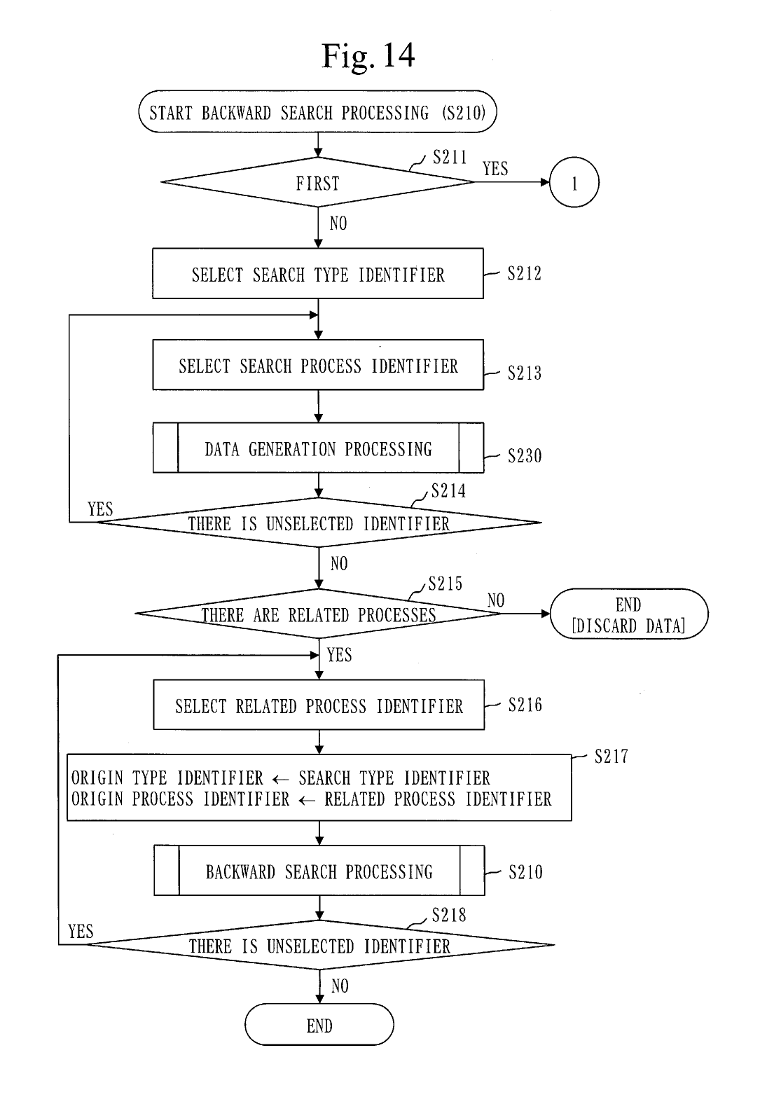

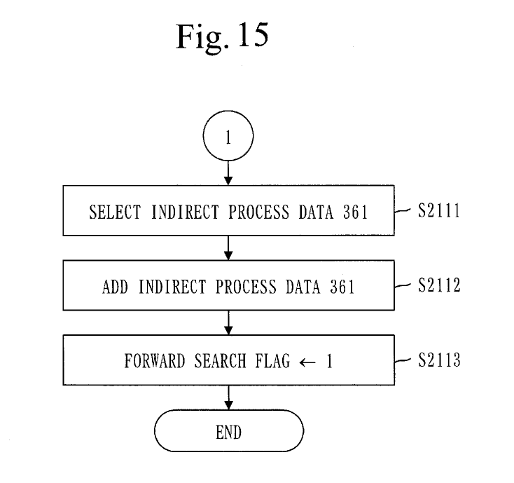

A procedure of the backward search processing (S210) will be described based on FIGS. 14 and 15.

At step S211, the indirect process searching unit 230 determines whether a number indicated by the origin type identifier is the first number.

The first number is a number indicating the first attack in a sequence of attacks. Specifically, the first number is the smallest one of the numbers included as attack type identifiers in the activity process list 330.

If the number indicated by the origin type identifier is the first number, processing proceeds to step S2111.

If the number indicated by the origin type identifier is not the first number, processing proceeds to step S212.

Description continues from step S2111 based on FIG. 15.

At step S2111, the indirect process searching unit 230 selects indirect process data 361 including relationship information indicating that there is a relationship, from pieces of indirect process data 361 having been generated in the last or previous data generation processings (S230) and having not been discarded.

At step S2112, the indirect process searching unit 230 adds the selected indirect process data 361 to the indirect process file 360.

At step S2113, the indirect process searching unit 230 sets the forward search flag to a first flag value.

The first flag value is a value indicating that a forward search processing (S220) is required. Specifically, the first flag value is 1.

After S2113, the backward search processing (S210) ends.

Referring back to FIG. 14, description continues from step S212.

At step S212, the indirect process searching unit 230 selects an attack type identifier different from the origin type identifier, as a search type identifier from the activity process list 330.

Specifically, the indirect process searching unit 230 selects, as a search type identifier, an attack type identifier indicating a number immediately before the number indicated by the origin type identifier.

At step S213, the indirect process searching unit 230 selects an unselected activity process identifier among activity process identifiers associated with the search type identifier, from the activity process list 330. The activity process identifier to be selected is referred to as search process identifier.

Specifically, the indirect process searching unit 230 selects an activity process identifier as a search process identifier in ascending order of attack start times, based on the attack start time associated with each activity process identifier.

Step S230 is a data generation processing.

At step S230, the indirect process searching unit 230 generates indirect process data 361 for a set of the origin process identifier and an indirect process identifier. The generated indirect process data 361 is stored in the storage unit 291.

A detail of the data generation processing (S230) will be described later.

At step S214, the indirect process searching unit 230 determines whether there is an unselected activity process identifier that is not selected as a search process identifier at step S213.

If there is an unselected activity process identifier, processing returns to step S213.

If there is no unselected activity process identifier, processing proceeds to step S215.

At step S215, the indirect process searching unit 230 determines whether there are related processes, using direct process data included in the direct process file 350 and the indirect process data 361 generated at step S230.

A related process is a search process related to an origin process.

Specifically, when there is direct process data, the indirect process searching unit 230 determines that there is an indirect process. In addition, when there is indirect process data 361 including relationship information indicating that there is a relationship, the indirect process searching unit 230 determines that there is a related process.

If there are related processes, processing proceeds to step S216.

If there are no related processes, the storage unit 291 discards the indirect process data 361 generated and stored at step S230.

In addition, the indirect process searching unit 230 sets the forward search flag to a second flag value (0). The second flag value is a value indicating that a forward search processing (S220) is not required. Specifically, the second flag value is 0.

Thereafter, the backward search processing (S210) ends.

At step S216, the indirect process searching unit 230 selects one unselected related process identifier.

The related process identifier is an identifier that identifies a related process.

Specifically, the indirect process searching unit 230 obtains, from the activity process list 330, attack start times associated with activity process identifiers identical to the respective related process identifiers. Then, the indirect process searching unit 230 selects a related process identifier in ascending order of attack start times.

At step S217, the indirect process searching unit 230 sets the search type identifier as a new origin type identifier, and sets the selected related process identifier as a new origin process identifier.

Then, a backward search processing (S210) is performed for a set of the new origin type identifier and the new origin process identifier.

After the backward search processing (S210), processing proceeds to step S218.

At step S218, the indirect process searching unit 230 determines whether there is an unselected related process identifier that is not selected at step S216.

If there is an unselected related process identifier, processing returns to step S216.

If there is no unselected related process identifier, the backward search processing (S210) ends.

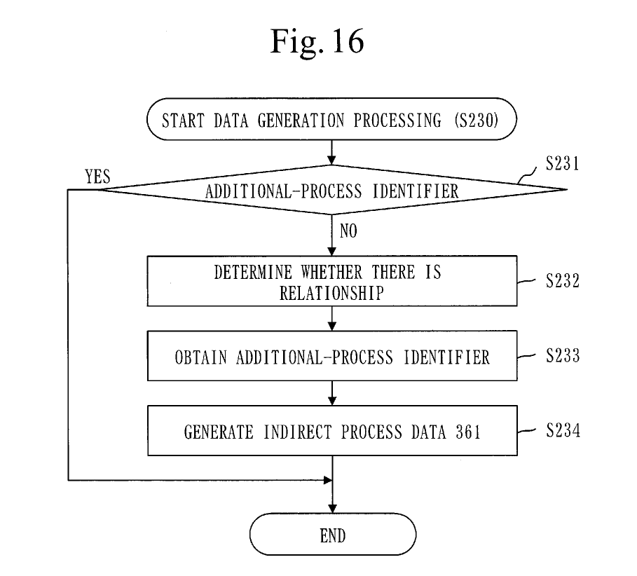

A procedure of the data generation processing (S230) will be described based on FIG. 16.

At step S231, the indirect process searching unit 230 determines whether the search process identifier is identical to a searched additional-process identifier.

The searched additional-process identifier is an additional-process identifier for a search process identifier selected last time or previously.

Specifically, the indirect process searching unit 230 determines whether pieces of indirect process data 361 generated and stored in the last or previous data generation processings (S230) include an additional-process identifier identical to the search process identifier. When the additional-process identifier is present, the search process identifier is identical to a searched additional-process identifier.

If the search process identifier is identical to a searched additional-process identifier, the data generation processing (S230) ends. By this, processings at step S232 to S234 are omitted.

If the search process identifier is different from a searched additional-process identifier, processing proceeds to step S232.

At step S232, the indirect process searching unit 230 determines whether there is a relationship between an origin process and a search process.

Specifically, the indirect process searching unit 230 determines whether the operation process list 340 includes a set of an operation-destination process identifier and an operation-source process identifier corresponding to a set of the origin process identifier and the search process identifier.

If the operation process list 340 includes a set of an operation-destination process identifier and an operation-source process identifier corresponding to a set of the origin process identifier and the search process identifier, there is a relationship between an origin process and a search process.

More specifically, the indirect process searching unit 230 makes a determination as follows:

First, the indirect process searching unit 230 retrieves pieces of operation process data 341 including an operation-destination process identifier identical to the origin process identifier, from the operation process list 340.

Then, the indirect process searching unit 230 determines whether an operation-source process identifier included in any of the pieces of operation process data 341 is identical to the search process identifier.

At step S233, the indirect process searching unit 230 obtains an additional-process identifier for the search process identifier.

Specifically, the indirect process searching unit 230 obtains an additional-process identifier as follows:

First, the indirect process searching unit 230 selects an operation-source process identifier identical to the search process identifier from the operation process list 340.

Then, the indirect process searching unit 230 obtains an operation-destination process identifier associated with the selected operation-source process identifier from the operation process list 340. The operation-destination process identifier to be obtained is the additional-process identifier.

At step S234, the indirect process searching unit 230 generates indirect process data 361.

Specifically, the indirect process searching unit 230 generates indirect process data 361 including the origin process identifier, the search type identifier, the search process identifier, relationship information, and the additional-process identifier. The relationship information indicates the result of the determination at step S232.

The storage unit 291 stores the generated indirect process data 361.

After step S234, the data generation processing (S230) ends.

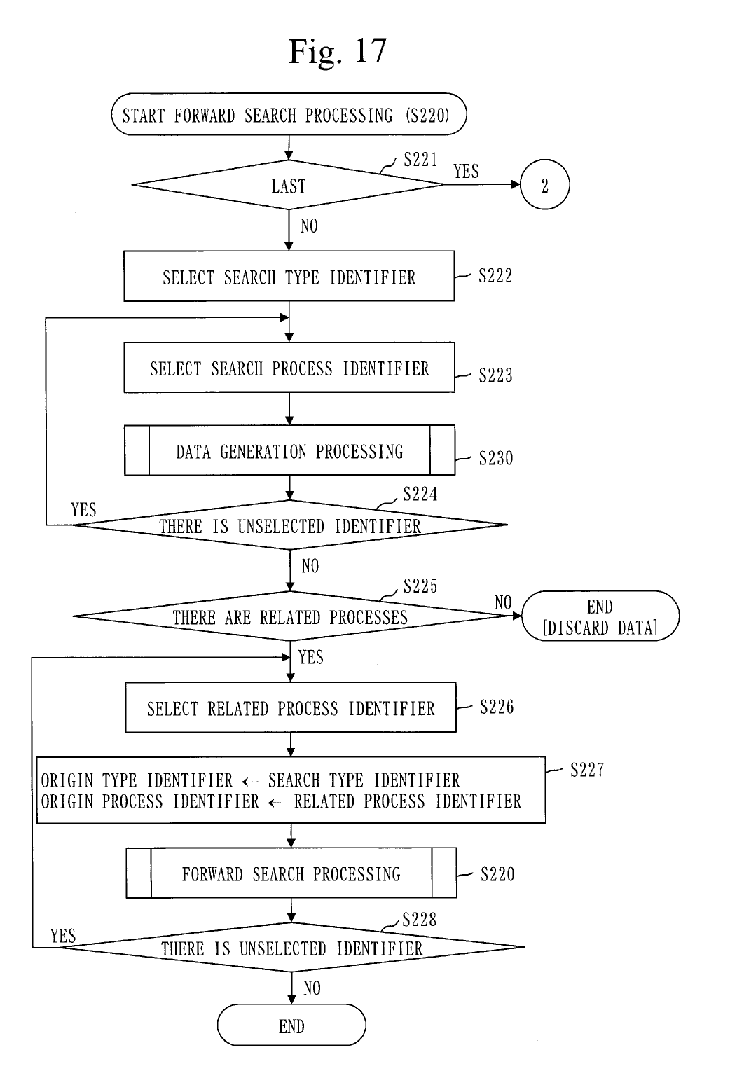

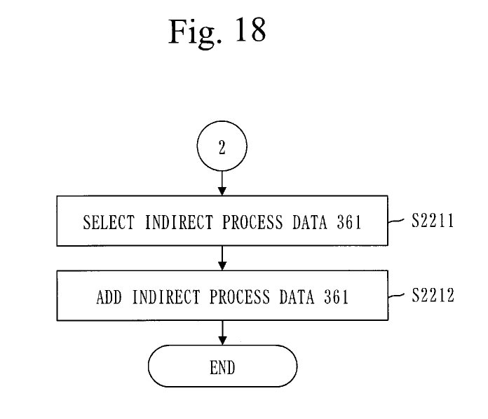

A procedure of the forward search processing (S220) will be described based on FIGS. 17 and 18.

Step S221 to S228 of the forward search processing (S220) correspond to step S211 to S218 of the backward search processing (S210).

At step S221, the indirect process searching unit 230 determines whether a number indicated by the origin type identifier is the last number.

The last number is a number indicating the last attack in the sequence of attacks. Specifically, the last number is the largest one of the numbers included as attack type identifiers in the activity process list 330.

If the number indicated by the origin type identifier is the last number, processing proceeds to step S2211.

If the number indicated by the origin type identifier is not the last number, processing proceeds to step S222.

Description continues from step S2211 based on FIG. 18.

At step S2211, the indirect process searching unit 230 selects indirect process data 361 including relationship information indicating that there is a relationship, from pieces of indirect process data 361 having been generated in the last or previous data generation processings (S230) and having not been discarded.

At step S2212, the indirect process searching unit 230 adds the selected indirect process data 361 to the indirect process file 360.

After step S2212, the forward search processing (S220) ends.

Referring back to FIG. 17, description continues from step S222.

At step S222, the indirect process searching unit 230 selects an attack type identifier different from the origin type identifier, as a search type identifier from the activity process list 330.

Specifically, the indirect process searching unit 230 selects, as a search type identifier, an attack type identifier indicating a number immediately after the number indicated by the origin type identifier.

At step S223, the indirect process searching unit 230 selects an unselected activity process identifier among activity process identifiers associated with the search type identifier, from the activity process list 330. The activity process identifier to be selected is referred to as search process identifier.

Specifically, the indirect process searching unit 230 selects an activity process identifier as a search process identifier in descending order of attack start times, based on the attack start time associated with each activity process identifier. Note, however, that the indirect process searching unit 230 does not select an activity process identifier associated with an earlier time than an attack start time associated with the origin process identifier.

At step S230, the indirect process searching unit 230 generates indirect process data 361 for a set of the origin process identifier and an indirect process identifier. The generated indirect process data 361 is stored in the storage unit 291.

At step S224, the indirect process searching unit 230 determines whether there is an unselected activity process identifier that is not selected as a search process identifier at step S223.

If there is an unselected activity process identifier, processing returns to step S223.

If there is no unselected activity process identifier, processing proceeds to step S225.

At step S225, the indirect process searching unit 230 determines whether there are related processes, using direct process data included in the direct process file 350 and the indirect process data 361 generated at step S230. A determination method is the same as that of step S215 of the backward search processing (S210).

If there are related processes, processing proceeds to step S226.

If there are no related processes, the storage unit 291 discards the indirect process data 361 generated and stored at step S230. Then, the forward search processing (S220) ends.

At step S226, the indirect process searching unit 230 selects one unselected related process identifier.

Specifically, the indirect process searching unit 230 obtains, from the activity process list 330, attack start times associated with activity process identifiers identical to the respective related process identifiers. Then, the indirect process searching unit 230 selects a related process identifier in descending order of attack start times.

At step S227, the indirect process searching unit 230 sets the search type identifier as a new origin type identifier, and sets the selected related process identifier as a new origin process identifier.

Then, a forward search processing (S220) is performed for a set of the new origin type identifier and the new origin process identifier.

After the forward search processing (S220), processing proceeds to step S228.

At step S228, the indirect process searching unit 230 determines whether there is an unselected related process identifier that is not selected at step S226.

If there is an unselected related process identifier, processing returns to step S226.

If there is no unselected related process identifier, the forward search processing (S220) ends.

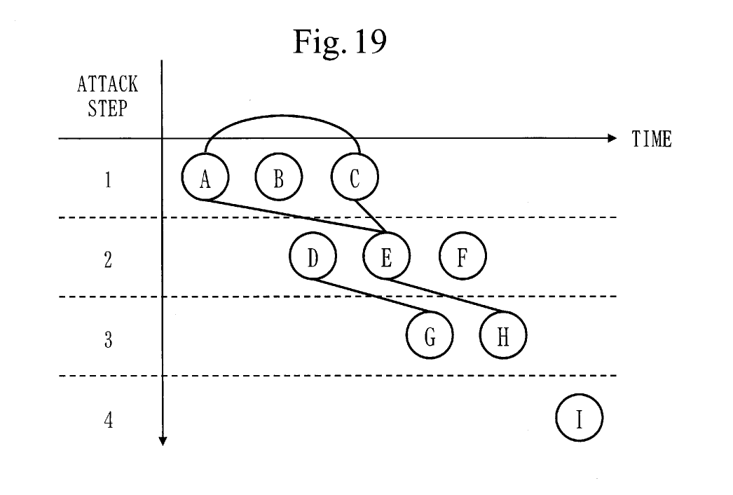

FIG. 19 illustrates an exemplary configuration of a process group.

In FIG. 19, a circle with an alphabet represents a process. In addition, a horizontal axis represents time, and a vertical axis represents attack step number. An attack step corresponds to an attack type identifier.

When the attack step “3” serves as an origin, an origin process is selected in descending order of times, i.e., in order of a process H and a process G.

When the attack step “3” serves as an origin, the attack step “2” serves as a search target. At this time, a search process is selected in ascending order of times, i.e., in order of a process D, a process E, and a process F.

Since the origin process H is related to the search process E, the attack step “2” serves as a new origin, the search process E serves as a new origin process, and the attack step “1” serves as a new search target. At this time, a search process is selected in ascending order of times, i.e., in order of a process A, a process B, and a process C.

The origin process E is related to the search process A, and the search process A is related to the additional process C. In addition, the origin process E is not related to the search process B. For a relationship between the origin process E and the search process C, since the process C is extracted as an additional process, a search is omitted.

Since a relationship for the attack steps “3” to “1” has been extracted, the attack step “4” serves as a search target. At this time, there is no relationship between the origin process E and a search process I.

As a result, a set of the process A, the process C, the process E, and the process H is extracted as a set of indirect processes.

A search is also performed for the origin process G likewise.

The attack step “2” is a search target, and a search process is selected in ascending order of times, i.e., in order of the process D and the process E. Since the process F is a process performed after the origin process G, the process F is not selected as a search process.

Since there is a relationship between the origin process G and the search process D, the attack step “2” serves as a new origin, the search process D serves as a new origin process, and the attack step “1” serves as a new search target. At this time, a search process is selected in ascending order of times, i.e., in order of the process A and the process B. Since the process C is a process performed after the origin process D, the process C is not selected as a search process.

There is no relationship between the origin process D and the search processes A and B.

As a result, a relationship for the attack steps “3” to “1” is not extracted, and a set of indirect processes including the process G is not extracted.

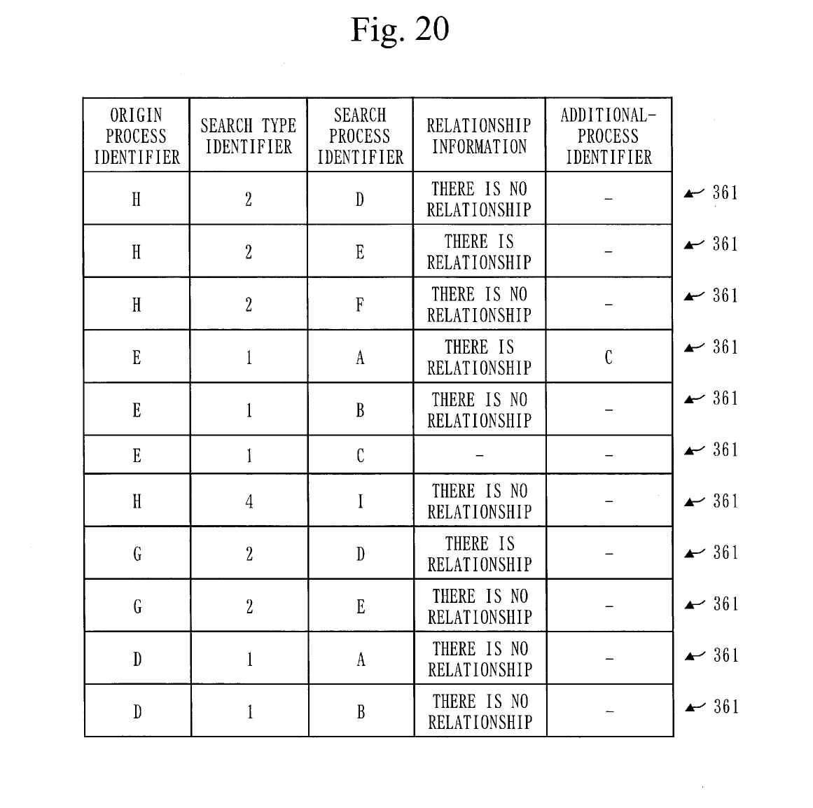

FIG. 20 illustrates pieces of indirect process data 361 generated when an indirect process search processing (S150) is performed targeted for the process group of FIG. 19. Some of the pieces of indirect process data 361 are direct process data.

Of the pieces of indirect process data 361 of FIG. 20, pieces of indirect process data 361 including relationship information indicating that there is a relationship are registered in the indirect process file 360 of FIG. 12.

Referring back to FIG. 3, description continues from step S160.

Step S160 is an attack determination process.

At step S160, the attack determining unit 240 determines a relationship between processes related to attacks, using the indirect process file 360. Then, the attack determining unit 240 generates attack determination results 370.

Specifically, the attack determining unit 240 extracts sets of indirect process identifiers from the indirect process file 360, and generates attack determination results 370 indicating the sets of indirect process identifiers. Some of the sets of indirect process identifiers are sets of direct process identifiers.

### Advantageous Effects of the First Embodiment

A relationship between processes related to attacks can be searched for using the activity log file 310 and the attack log file 320.

Since the search is performed from a selected origin, search paths are narrowed down and the search is performed efficiently.

***Other Configurations***

In the process search system 100, two or three of the target apparatus 110, the attack detection apparatus 120, and the process search apparatus 200 may be one apparatus.

### Second Embodiment

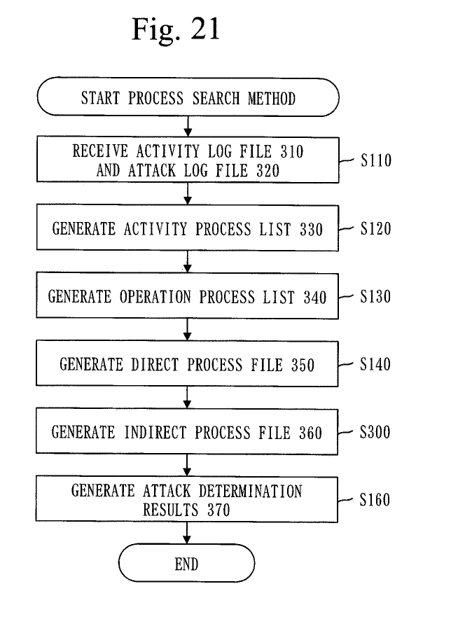

A mode in which a search is performed targeted for all activity process identifiers included in the activity process list 330 will be described based on FIGS. 21 to 26. Note, however, that overlapping description with the first embodiment is omitted or simplified.

***Description of Configurations***

A configuration of the process search system 100 is the same as that of the first embodiment.

A configuration of the process search apparatus 200 is the same as that of the first embodiment.

***Description of Operation***

A process search method will be described based on FIG. 21.

Step S110 to S140 and S160 are the same as those of the first embodiment.

Step S300 corresponds to step S150 of the first embodiment.

Step S300 is an indirect process search processing.

At step S300, the indirect process searching unit 230 searches for sets of indirect process identifiers using the activity process list 330 and the operation process list 340, and generates an indirect process file 360.

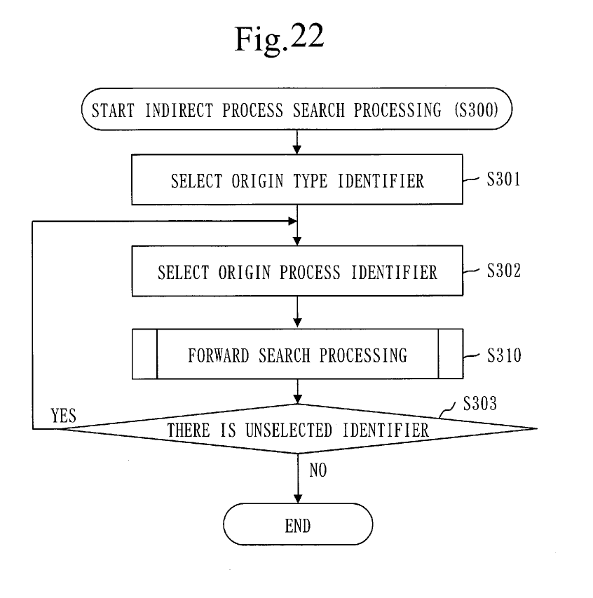

A procedure of the indirect process search processing (S300) will be described based on FIG. 22.

At step S301, the indirect process searching unit 230 selects an origin type identifier from the attack type identifiers included in the activity process list 330.

Specifically, the indirect process searching unit 230 selects an attack type identifier indicating the first number, as an origin type identifier.

At step S302, the indirect process searching unit 230 selects an unselected activity process identifier as an origin process identifier from the activity process list 330.

Specifically, the indirect process searching unit 230 selects an activity process identifier as an origin process identifier in ascending order of attack start times.

Step S310 is a forward search processing.

The forward search processing (S310) will be described later.

After step S310, processing proceeds to step S303.

At step S303, the indirect process searching unit 230 determines whether there is an unselected activity process identifier that is not selected as an origin process identifier at step S302.

If there is an unselected activity process identifier, processing returns to step S302.

If there is no unselected activity process identifier, the indirect process search processing (S300) ends.

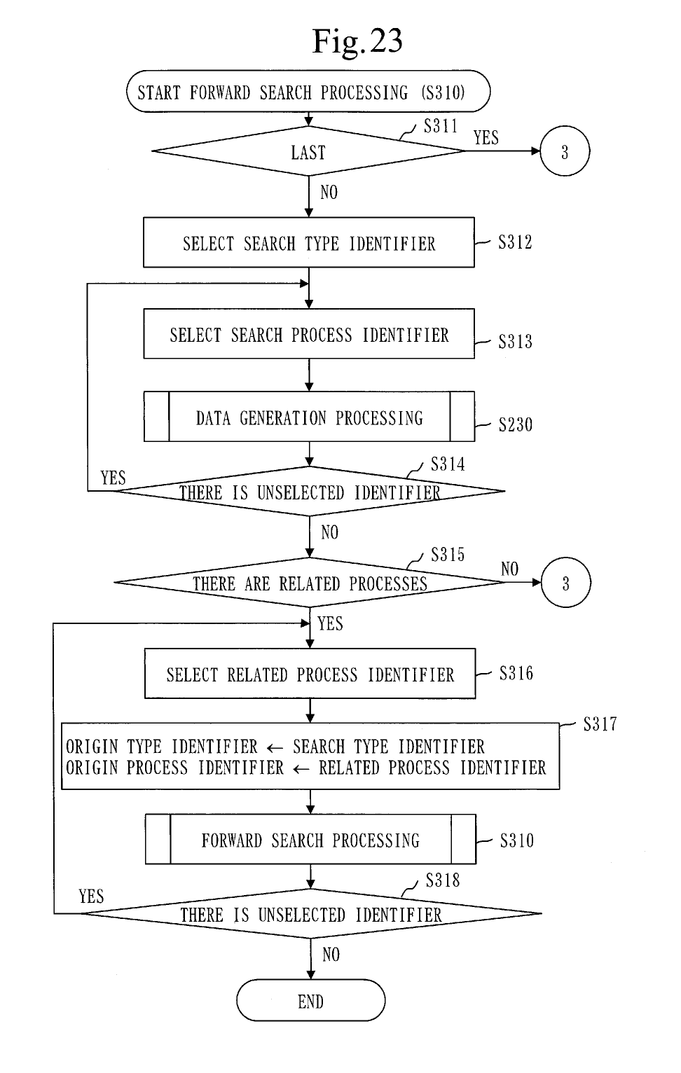

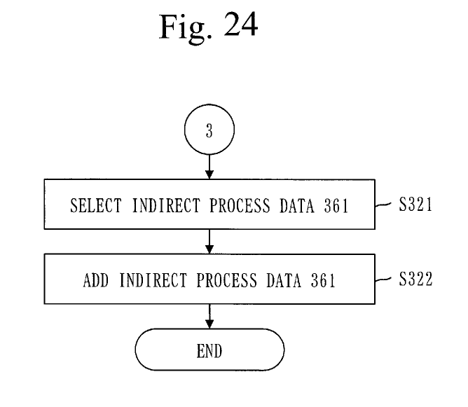

A procedure of the forward search processing (S310) will be described based on FIGS. 23 and 24.

Processings at step S311 to S318 are the same as those at step S221 to S228 described based on FIG. 17 in the first embodiment.

Note, however, that, when a number indicated by the origin type identifier is the last number at step S311, processing proceeds to step S321.

Note also that, when there is no related process at step S315, processing proceeds to step S321.

Step S321 and S322 will be described based on FIG. 24.

Step S321 and S322 are the same as step S2211 and S2212 described based on FIG. 18 in the first embodiment.

A flow of the indirect process search processing (S300) will be described using the process group of FIG. 19 as an example.

The attack step “1” is an origin, and an origin process is selected in ascending order of times, i.e., in order of the process A, the process B, and the process C.

When the attack step “1” is an origin, the attack step “2” is a search target. At this time, a search process is selected in descending order of times, i.e., in order of the process F, the process E, and the process D.

The origin process A is related to the search process E, and the origin process A is related to the additional process C.

Then, the attack step “2” serves as a new origin, the search process E serves as a new origin process, and the attack step “3” serves as a new search target. Then, the process H is selected as a search process.

Since the origin process E is related to the search process H, the attack step “3” serves as a new origin, the search process H serves as a new origin process, and the attack step “4” serves as a new search target. Then, the process I is selected as a search process.

Since the origin process H is not related to the search process I, the search ends.

As a result, a set of the process A, the process C, the process E, and the process H is extracted as a set of indirect processes.

A search is also performed for the origin process B likewise.

The attack step “2” serves as a search target, but the origin process B is not related to any of the search processes F, E, and D. Hence, the search ends.

A search is also performed for the origin process C likewise.

The attack step “2” serves as a search target, and the process F is selected as a search process. Since the process D is a process performed earlier than the origin process C, the process D is not selected as a search process. In addition, since the process E has been extracted as an additional process, the process E is not selected as a search process.

Since the origin process C is not related to the search process F, the search ends.

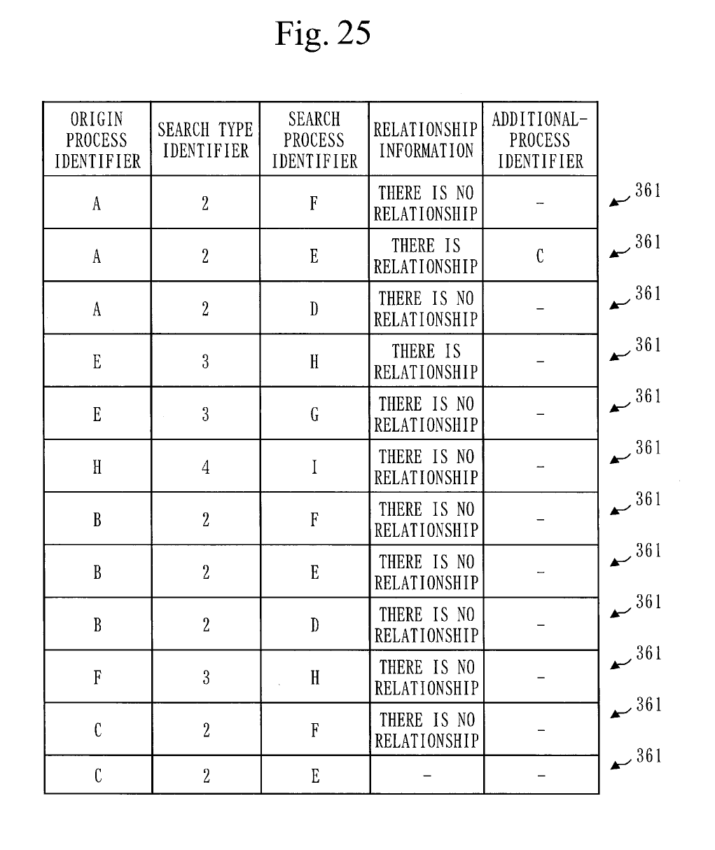

FIG. 25 illustrates pieces of indirect process data 361 generated when an indirect process search processing (S300) is performed targeted for the process group of FIG. 19.

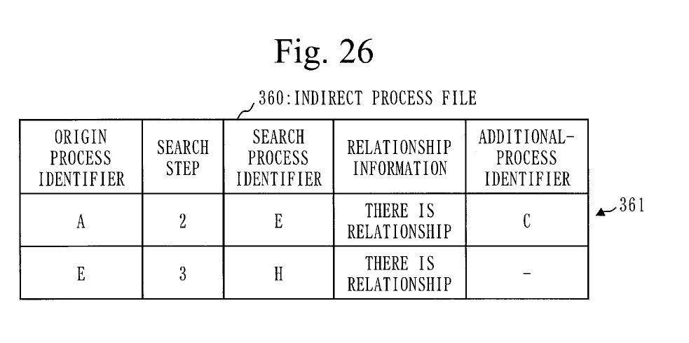

FIG. 26 illustrates an indirect process file 360 generated by extracting pieces of indirect process data 361 representing sets of indirect processes, from the pieces of indirect process data 361 of FIG. 25.

### Advantageous Effects of the Second Embodiment

Since an attack type identifier with the first number is an origin, a search can be performed targeted for all activity processes included in the activity process list 330.

### Supplementary Remarks on the Embodiments

In the embodiments, the functions of the process search apparatus 200 may be implemented by hardware.

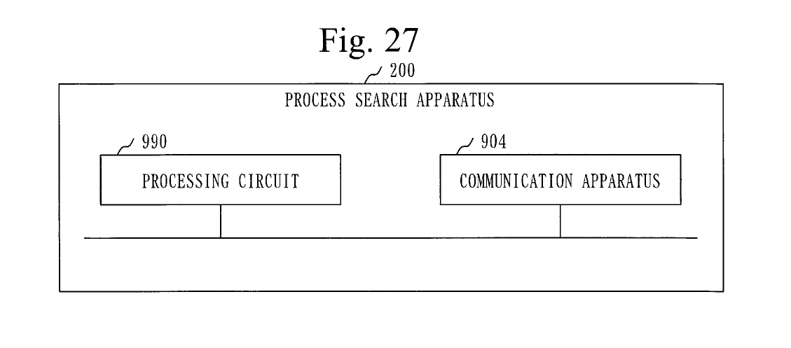

FIG. 27 illustrates a configuration for when the functions of the process search apparatus 200 are implemented by hardware.

The process search apparatus 200 includes a processing circuit 990. The processing circuit 990 is also referred to as processing circuitry.

The processing circuit 990 is a dedicated electronic circuit that implements the functions of the “units” described in the embodiments. The “units” also include the storage unit 291.

Specifically, the processing circuit 990 is a single circuit, a combined circuit, a programmed processor, a parallel programmed processor, a logic IC, a GA, an ASIC, an FPGA, or a combination thereof. The GA is the abbreviation for gate array, the ASIC is the abbreviation for application specific integrated circuit, and the FPGA is the abbreviation for field programmable gate array.

Note that the process search apparatus 200 may include a plurality of processing circuits 990, and the plurality of processing circuits 990 may implement the functions of the “units” in cooperation with each other.

The functions of the process search apparatus 200 may be implemented by a combination of software and hardware. That is, some of the “units” may be implemented by software and the rest of the “units” may be implemented by hardware.

The embodiments are exemplification of preferred modes and are not intended to limit the technical scope of the present invention. The embodiments may be partially implemented or may be implemented in combination with other modes. The procedures described using the flowcharts, etc., may be changed as appropriate.

### REFERENCE SIGNS LIST

100: process search system, 101: network, 110: target apparatus, 111: log collecting unit, 120: attack detection apparatus, 121: attack detecting unit, 200: process search apparatus, 210: process list generating unit, 220: direct process searching unit, 230: indirect process searching unit, 240: attack determining unit, 291: storage unit, 292: communicating unit, 293: receiving unit, 294: transmitting unit, 310: activity log file, 311: activity log, 320: attack log file, 321: attack log, 330: activity process list, 331: activity process data, 340: operation process list, 341: operation process data, 350: direct process file, 360: indirect process file, 361: indirect process data, 370: attack determination result, 901: processor, 902: memory, 903: auxiliary storage apparatus, 904: communication apparatus, 905: receiver, 906: transmitter, 990: processing circuit.

1-15. (canceled)

16. A process search apparatus which searches for a process related to an attack on a target apparatus,
the process search apparatus comprising:
processing circuitry
to store an activity process list in which an attack type identifier that identifies a detected attack among a plurality of attacks that are in order and an activity process identifier of an activity process performed during a time period during which the attack is detected are associated with each other; and an operation process list in which an operation-source process identifier of an operation-source process having operated another process during the time period during which the attack is detected and an operation-destination process identifier of an operation-destination process that is the another process operated are associated with each other, and
to search for a set of indirect process identifiers using the activity process list and the operation process list, the set of indirect process identifiers corresponding to a set of an activity process identifier associated with a start type identifier being one of attack type identifiers and an activity process identifier associated with an attack type identifier being different from the start type identifier, and corresponding to a set of an operation-source process identifier and an operation-destination process identifier.

17. The process search apparatus according to claim 16, wherein the processing circuitry:
selects an origin type identifier from attack type identifiers included in the activity process list, based on a number of activity process identifiers associated with each of the attack type identifiers, the origin type identifier being an attack type identifier serving as an origin of a search; and
searches for the set of indirect process identifiers using activity process identifiers associated with the selected origin type identifier.

18. The process search apparatus according to claim 17, wherein the processing circuitry selects, as the origin type identifier, an attack type identifier with a smallest number of activity process identifiers associated with the attack type identifier among the attack type identifiers included in the activity process list.

19. The process search apparatus according to claim 17, wherein the processing circuitry:
selects an activity process identifier associated with the origin type identifier, as an origin process identifier from the activity process list;
selects an attack type identifier different from the origin type identifier, as a search type identifier from the activity process list;
selects an activity process identifier associated with the search type identifier, as a search process identifier from the activity process list; and
determines whether the operation process list includes a set of an operation-destination process identifier and an operation-source process identifier corresponding to a set of the origin process identifier and the search process identifier.

20. The process search apparatus according to claim 19, wherein
the attack type identifier is a number indicating order of attacks, and
the processing circuitry selects, as the search type identifier, an attack type identifier indicating a number immediately before a number indicated by the origin type identifier.

21. The process search apparatus according to claim 20, wherein when the operation process list includes a set of an operation-destination process identifier and an operation-source process identifier corresponding to a set of the origin process identifier and the search process identifier, and the number indicated by the search type identifier is a first number, the processing circuitry generates the set of the origin process identifier and the search process identifier as the set of indirect process identifiers.

22. The process search apparatus according to claim 21, wherein
when the operation process list includes the set of an operation-destination process identifier and an operation-source process identifier corresponding to the set of the origin process identifier and the search process identifier, but the number indicated by the search type identifier is not the first number, the processing circuitry:
selects an activity process identifier associated with the search type identifier, as a new origin process identifier;
selects an attack type identifier indicating a number immediately before the number indicated by the search type identifier, as a new search type identifier,
selects an activity process identifier associated with the new search type identifier, as a new search process identifier; and
generates, when the operation process list includes a set of an operation-destination process identifier and an operation-source process identifier corresponding to a set of the new origin process identifier and the new search process identifier and the number indicated by the new search type identifier is the first number, the set of the origin process identifier and the search process identifier and the set of the new origin process identifier and the new search process identifier, as the set of indirect process identifiers.

23. The process search apparatus according to claim 20, wherein
the activity process list includes an attack start time that is a start time of the time period during which an attack is detected, and that is a time associated with an attack type identifier and an activity process identifier, and
the processing circuitry selects each activity process identifier associated with the search type identifier, as the search process identifier, in ascending order of attack start times from the activity process list.

24. The process search apparatus according to claim 23, wherein
the processing circuitry:
selects an operation-source process identifier identical to the search process identifier from the operation process list, and obtains an operation-destination process identifier associated with the selected operation-source process identifier, as an additional-process identifier from the operation process list; and
generates a set of the origin process identifier, the search process identifier, and the additional-process identifier as the set of indirect process identifiers when the operation process list includes the set of an operation-destination process identifier and an operation-source process identifier corresponding to the set of the origin process identifier and the search process identifier, and the number indicated by the search type identifier is a first number.

25. The process search apparatus according to claim 24, wherein when the search process identifier is identical to an additional-process identifier for a search process identifier selected previously, the processing circuitry omits a processing for the set of the origin process identifier and the search process identifier.

26. The process search apparatus according to claim 21, wherein the processing circuitry:
selects an attack type identifier indicating a number immediately after the number indicated by the origin type identifier, as a new search type identifier;
selects an activity process identifier associated with the new search type identifier, as a new search process identifier, and
generates, when the operation process list includes a set of an operation-destination process identifier and an operation-source process identifier corresponding to a set of the origin process identifier and the new search process identifier, the set of the origin process identifier and the new search process identifier as the set of indirect process identifiers.

27. The process search apparatus according to claim 26, wherein
the activity process list includes an attack start time that is a start time of the time period during which the attack is detected, and that is a time associated with the attack type identifier and the activity process identifier, and
the processing circuitry selects each activity process identifier associated with the search type identifier, as the new search process identifier, in descending order of attack start times from the activity process list.

28. The process search apparatus according to claim 27, wherein
the processing circuitry:
selects an operation-source process identifier identical to the new search process identifier from the operation process list, and obtains an operation-destination process identifier associated with the selected operation-source process identifier, as an additional-process identifier from the operation process list; and
adds the obtained additional-process identifier to the set of the origin process identifier and the search process identifier.

29. The process search apparatus according to claim 28, wherein when the new search process identifier is an identifier identical to an additional-process identifier for a search process identifier selected previously, the processing circuitry omits a processing for the set of the origin process identifier and the new search process identifier.

30. A computer-readable recording medium storing a process search program which searches for a process related to an attack on a target apparatus using an activity process list and an operation process list, wherein
the activity process list is a list in which an attack type identifier that identifies a detected attack among a plurality of attacks that are in order and an activity process identifier of an activity process performed during a time period during which the attack is detected are associated with each other,
the operation process list is a list in which an operation-source process identifier of an operation-source process having operated another process during the time period during which the attack is detected and an operation-destination process identifier of an operation-destination process that is the another process operated are associated with each other, and
the process search program causes a computer to perform an indirect process search processing for searching for a set of indirect process identifiers using the activity process list and the operation process list, the set of indirect process identifiers corresponding to a set of an activity process identifier associated with a start type identifier being one of attack type identifiers and an activity process identifier associated with an attack type identifier being different from the start type identifier, and corresponding to a set of an operation-source process identifier and an operation-destination process identifier.
